(19) United States
(12) Patent Application Publication
(10) Pub. No.: US 2010/0074625 A1
(43) Pub. Date: Mar. 25, 2010

(54) Apparatus for voice communication using an incoherent light source

(76) Inventors: John C. Northcott, Seven Fields, PA (US); James M. Helms, Fort Myers, FL (US); Ricky A. Houghton, Wexford, PA (US); Chris Wieland, Loveland, CO (US); Xiaolu Chen, Cranberry Township, PA (US); James A. Retter, Butler, PA (US)

Correspondence Address: KAREN TANG-WAI SODINI, 216 horseshoe drive, MARS, PA, 16046, US

(21) Appl. No.: 12/584,067

(22) Filed: Aug. 28, 2009

Related U.S. Application Data
(60) Provisional application No. 61/190,847, filed on Sep. 3, 2008.

(51) Int. Cl. H04B 10/00; G10L 19/00

(52) U.S. Cl. 398/130; 704/201; 704/E19.001

(57) ABSTRACT

A communication system for communicating spoken speech, based on switching on and off a visible or infrared light source in a pattern corresponding to the spoken speech. The communication system provides for rapid retransmission/rebroadcast of messages received from other communication systems, to allow communication over a longer range than would otherwise be possible, or between two points not along a line of sight. The system may include a light source also used (at the same time) for providing illumination, such as a light source that is part of a lightbar mounted on a vehicle.

### CROSS REFERENCE TO RELATED APPLICATION

Reference is made to and priority claimed from U.S. provisional application Ser. No. 61/190,847 filed Sep. 3, 2008.

### TECHNICAL FIELD

The present invention pertains to the field of telecommunications. More particularly, the present invention pertains to communication using an ordinary (non-laser) LED (light emitting diode) light source, either visible or infrared.

### BACKGROUND OF THE INVENTION

There are situations in which communication using radio waves is made difficult because of the use of jamming devices. For example, in a convoy of military vehicles, each vehicle may protect itself by creating a “bubble” about itself, i.e. a zone of short-range jamming signals aimed at preventing remote detonation of an IED (improvised explosive device) located within the zone. Because of such jamming signals, the vehicle is not able to communicate by radio with another vehicle within its own bubble, since the jamming signals from the vehicle extend to the location of the other vehicle.

It is known in the art to use non-coherent infrared (IR) light for communication. From the Wikipedia article on “Infrared” (i.e. on the Internet at: http://en.wikipedia.org/wiki/Infrared#Communications):
R data transmission is . . . employed in short-range communication among computer peripherals and personal digital assistants. These devices usually conform to standards published by IrDA, the Infrared Data Association. Remote controls and IrDA devices use infrared light-emitting diodes (LEDs) to emit infrared radiation which is focused by a plastic lens into a narrow beam. The beam is modulated, i.e. switched on and off, to encode the data. The receiver uses a silicon photodiode to convert the infrared radiation to an electric current. It responds only to the rapidly pulsing signal created by the transmitter, and filters out slowly changing infrared radiation from ambient light . . . .

The prior art also teaches that both military vehicles and civilian vehicles are sometimes equipped with so-called lightbars, such as described by U.S. Pat. No. 7,387,414. In many applications of lightbars such as set out in the '414 patent, a vehicle is equipped with such lightbars so as to provide illumination in all directions, i.e. 360-degree illumination.

Thus, the prior art makes available a technology—communication using non-coherent IR light—that would be useable to enable vehicles located within each other's bubble to nevertheless communicate data with each other (computer/device to computer/device communication), and also makes available lightbars providing both visible and IR light. What is needed is a way to switch on and off IR light, or even visible light, so as to provide user-to-user voice communication, and in particular in case of communication between moving vehicles, possibly using light sources already used by the vehicle for illumination, such as light sources in a lightbar.

### DISCLOSURE OF INVENTION

Accordingly, a communication system is provided, for communicating spoken speech, i.e. for voice communication. A communication system according to the invention typically includes, at a transmitter side, components for representing spoken speech as a series of on and off switch commands, i.e. an encoder for encoding the spoken speech in terms of switch commands, and a light, such as an infrared light LED (light emitting diode) or a visible light LED, receptive to the switch commands, for providing switched light. The light may be either a visible light or an infrared light/illuminator. Further, and preferably under some circumstances, the light may be included in a lightbar, i.e. an apparatus mounted on a vehicle for providing lighting auxiliary to driving lights/headlamps.

At a receiver side, the invention includes a photodetector to detect the switched light and thus enable determining the switch commands used to create the switched light (which determination is provided by what is here called a modulator), and a decoder for translating the switch commands back to the spoken speech. In case of a lightbar application, the photodetectors could be embedded in the lightbar. For lightbars providing 360-degree illumination (using e.g. four lightbars facing 90 degrees apart) the communication system could include photodetectors disposed so that there is one photodetector for each of four mutually more or less orthogonal directions.

A communication system according to the invention, i.e. for communicating spoken speech, can be adapted to provide data communication in addition to voice communication, since a communication system according to the invention is a digital communication system (i.e. it communicates a bit stream representing the spoken speech), which is therefore suitable for communicating data (which would also be represented by a bit stream).

### BRIEF DESCRIPTION OF THE DRAWINGS

The features and advantages of the invention will become apparent from a consideration of the subsequent detailed description presented in connection with accompanying drawings, in which:

FIG. 1 is a block diagram/flow diagram of the transmitter side of one communication system according to the invention and a receiver side of another communication system according to the invention; and

FIG. 2 is a block diagram/flow diagram of a communication system according to the invention, illustrating echo operation.

FIG. 3 is a top view of an embodiment of a light detector used on a receiver side of a communication according to the invention.

### DRAWINGS LIST OF REFERENCE NUMERALS

The following is a list of reference labels used in the drawings to label components of different embodiments of the invention, and the names of the indicated components.
11 transmitter side
11a microphone
11b speech encoder
11c modulator
11d on/off switch
11f light source
12 receiver side
12a photodetector
12b demodulator
12c speech/data decoder
12d speaker
31 lens
32a-e IR detectors

### DETAILED DESCRIPTION

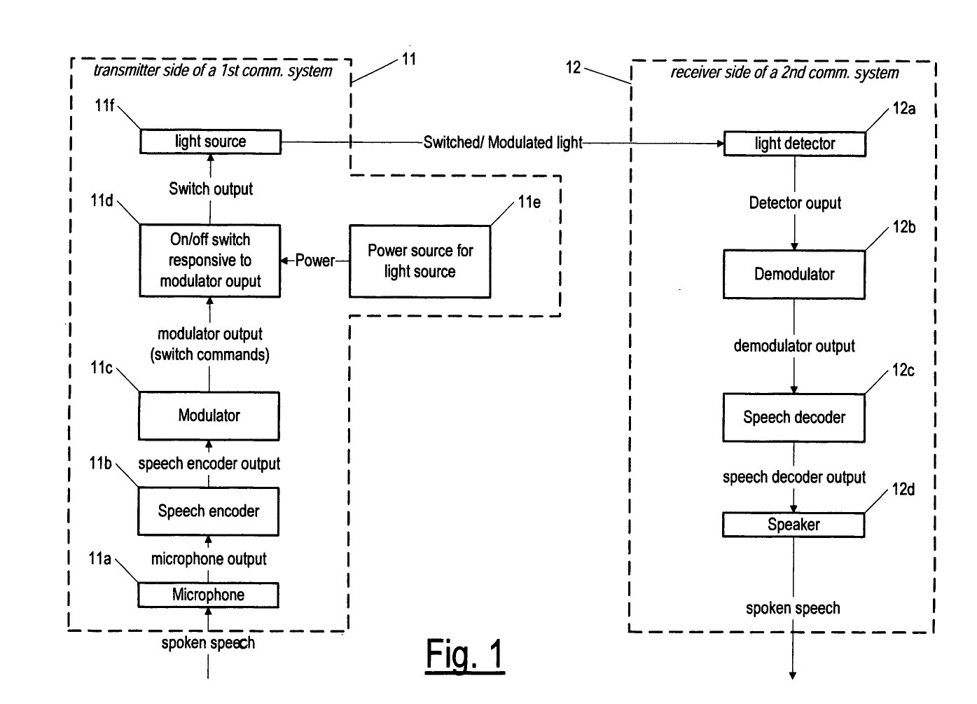

Referring now to FIG. 1, the invention provides a communication system having a transmitter side (transmitter assembly) 11 and a receiver side (receiver assembly) 12, for transmitting and receiving, respectively, spoken speech, i.e. for providing voice communication, although in FIG. 1, only the transmitter side is shown for a first communication system according to the invention, and only the receiver side is shown for a second communication system according to the invention.

In an illustrative embodiment, the invention provides a communication system including, at the transmitter side 11, a microphone 11a, responsive to the spoken speech, for providing as its output an electrical signal (typically analog) corresponding to the spoken speech. The output of the microphone is fed to a speech encoder 11b, which provides as an output a digital representation of the speech, which could be binary or other. The speech encoder could be any number of prior art vocoders (i.e. voice encoders).

The output of the speech encoder 11b—a stream of digital (not necessarily binary) information—is input to what is here called a modulator 11c, which produces switch signals based on the speech encoder output.

In some embodiments of the invention the modulator 11c uses Manchester encoding to encode a bit stream representing spoken speech (produced by a vocoder), and to then provide switch commands corresponding to the encoding. Manchester encoding (also known as Phase Encoding) is a line coding in which the encoding of each data bit has at least one transition and occupies the same time. It is, therefore, self-clocking, which means that a clock signal can be recovered from the encoded data.

In some embodiments, the modulator 11c provides a switch “on” command for a bit of value “1” and a switch “off” command for a bit of value “0.” In other embodiments, the modulator provides a command to switch on and off repetitively at a first frequency for a bit of value “1,” and a command to switch on and off repetitively at a second frequency for a bit of value “0.” (In both cases in such other embodiments, the switching on and off is continued for some pre-determined period of time, sufficient to provide a reasonable compromise between throughput and reliability of the wireless link.)

In other words, the modulator maps the bit stream representing spoken speech to switch commands using Manchester encoding. The switch commands thus produced, or equivalently, the bit stream produced by the Manchester encoding, function as modulation symbols.

The output of the modulator 11c—a series of switch commands—is then input to an on/off switch 11d in order to produce the light pattern determined by the modulator.

The resulting action of the switch 11d controls a power source 11e providing power to a light source 11f. The light source could be an LED light source, either a visible light LED or an infrared light LED. For visible light, other kinds of light sources can be used, provided that they can be switched on and off quickly enough.

As a result of the action of the switch 11d, the light source 11f (which could also be any other sort of light able to be switched on and off at a rate of at least about 2 kHz) turns on and off in a way that represents the spoken speech being transmitted, according to an on/off pattern.

The switching, is, advantageously in some applications, at such a frequency as not to be discernible by the human eye, even using equipment sensitive to IR light (e.g. night vision goggles). In other words, the switching should be fast enough that the light appears to a person (using e.g. night vision goggles in case of using IR light) to be on continuously, and not switched on and off. To ensure such an apparently steady “on” state, the switching should be at least seventy times per second.

The transmission could include some basis for error checking or even forward error correction, and a protocol could be used in which a repeat request is made by the receiver side in case of an error being detected (and not being correctable). The transmission could include such error detection and/or correction capabilities because of processing by the speech encoder 11b or the modulator 11c. In other words, either the speech encoder or the modulator could be implemented to provide such error detection and/or correction capabilities. In addition, the spoken speech could be encrypted by either the speech encoder or the modulator.

At the receiver side 12 of a communication system according to the invention, a photodetector (light detector) 12a produces a detector output in response to the on/off light pattern produced by the light source 11f, i.e. the detector produces signals indicative of the on/off light pattern. The detector output is fed to a demodulator 12b that produces as an output what is substantially the encoder output produced by the speech encoder 11b at the transmitter side 11, any difference being attributable to errors in detection (as a result, typically, of errors in transmission). Thus, the demodulator output is the coded representation of the speech being transmitted (and should correspond, at least approximately, to the output of the speech encoder/vocoder 11b of the transmitter side 11).

The demodulator output is fed to a speech decoder 12c (the decoder portion of a vocoder), having as an output (analog or digital) signals for driving a speaker 12d, which uses the decoder output to reproduce the transmitted spoken speech (as received, i.e. with any errors not able to be corrected by the receiver).

In some embodiments, the communication system is integrated into a lightbar, such as a lightbar used on military vehicles or civil vehicles (e.g. police or security vehicles), e.g. a lightbar as set out in U.S. Pat. No. 7,387,414. Such embodiments can be said to provide a “talking lightbar.” In such embodiments, the lightbar includes the transmitter side 11 of the above-described communication system, and perhaps also the receiver side 12, although the receiver side may, in some embodiments, be provided outside of the housing of the lightbar.

In some talking lightbar embodiments, where the communication system is therefore mounted on a vehicle, light is transmitted in all directions in the horizontal plane (360 degrees) by one or more lightbars on the vehicle, and the communication system is advantageously provided (in such applications) so as to be able to transmit using several lights (e.g. four lights) in all directions, simultaneously or otherwise, and so as to be able to receive transmissions coming from all directions, simultaneously or otherwise.

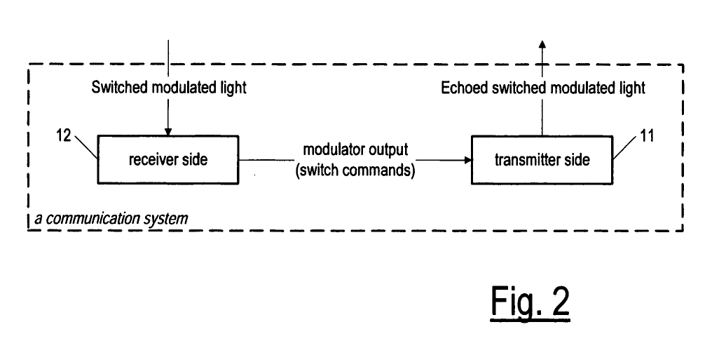

Advantageously in such applications, a communication system according to the invention is configured to echo a received transmission that it did not itself previously transmit. Thus, for example, and now referring to FIG. 2, if a first vehicle issues a transmission and a second vehicle receives the transmission, the second vehicle would retransmit (echo/relay) the same transmission (with low latency, i.e. effectively instantaneously) and thereby provide the transmission to a third vehicle out of range of the first vehicle, either because the third vehicle is not within the line of sight of the first vehicle, or is too far away. The first vehicle might also receive the echoed transmission, but would not itself retransmit the echoed transmission, and so not cause repeating echoes.

In order to achieve such echo operation without the first vehicle repeating its transmission or otherwise having repeating echoes occur, a communication system according to the invention could include in each transmission a header in turn including an identifier of the transmission, and the transmitter side 11 and the receiver side 12 could be tied together directly, as in FIG. 2. Then when a receiver 12 of a vehicle receives a transmission, it would demodulate the transmission to the extent that the header could be read to determine whether the transmission was already transmitted by the vehicle (either because the transmission originated in the vehicle or was already relayed once by the vehicle), and if not it would immediately provide the detected switch commands to the transmitter 11, which would then echo/relay the transmission, and also continue demodulation of the transmission, but otherwise (if the transmission was determined to have already been transmitted by the vehicle), it would disregard the received transmission.

Thus, in some embodiments voice communication is passed from vehicle to vehicle via a relay function in order to reach all vehicles in a convoy or in a general area. The relay function, in some such embodiments, resembles a traditional Ethernet switch or Ethernet network equipment, i.e. it routes data from point to point. Each packet of voice communication in some embodiments is transmitted as a message with a header field indicative of the vehicle originating the voice packet and uniquely identifying the message (e.g. message number 2345 from vehicle number 1). Each vehicle receiving a packet of voice communication rebroadcasts the packet, provided it has not already rebroadcast the message. For this, in a typical embodiment, each vehicle would keep a rolling list of transmission identifiers for identifying transmissions the vehicle transmitted within some predetermined most recent time period, and would only retransmit a received transmission if the identifier does not appear on the rolling list.

The outputs of the photodetectors would advantageously be high-pass filtered, so as to pass only detector outputs corresponding to the rapid on/off switching of the transmitting light, corresponding to the spoken speech being communicated.

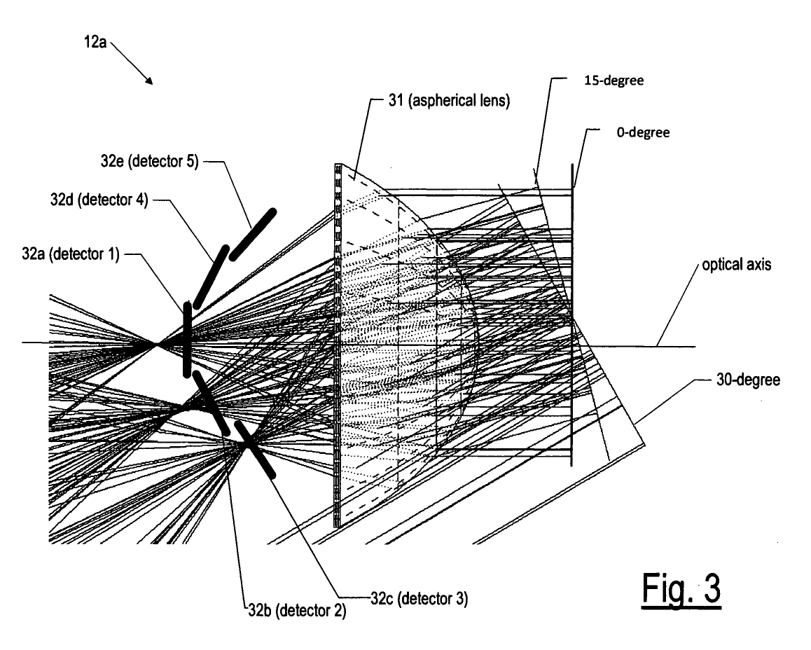

In some embodiments, and now referring to FIG. 3, a single aspherical lens 31, having an optical axis, is used as part of the light detector 12a of the receiving side 12, for detecting transmitted IR light, i.e. collecting the IR signal, and distributing it over one or more IR detectors 32a-e. The IR detectors are arranged with respect to the lens, with one photodetector 32a located on the optical axis, so as to cover a large field of view (FOV), or in other words, so that the light passing through the lens impinges on as much of the several IR detectors as possible, thereby maximizing optical-electrical conversion efficiency. Thus, the IR light is intentionally not in focus, i.e. it is un-focused, at the point where it reaches the IR detectors. In other words, of the one or more photodetectors that are used, the photodetector 32a placed on the optical axis is located at a point other than a focal point of the lens, so that the light is distributed over as much of the photodetector as possible. The off-axis photodetectors 32b-e are located at approximately the same distance from the center of the lens, as shown in FIG. 3.

Each IR detector is typically provided inside a frame, but to place the detectors closer to each other, the frame is removed in some embodiments, but there may still be some gaps between the detectors. However, due to the un-focused positioning of the IR detectors relative to the lens, any IR signal within the FOV will be smeared over an area larger than any of the inter-detector gaps, and so will be received by at least one (and typically at least two) detectors.

Referring still to FIG. 3, an embodiment of the light detector 12a according to the invention is shown as including five IR detectors 32a 32b 32c 32d 32e disposed in spaced apart relation to a lens 31, such as an aspherical lens, and arranged symmetrically about the optical axis of the lens, as shown. FIG. 3 shows IR rays coming from three different angles (0, 15 and 30 degrees relative to the optical axis), and illustrates that for the particular arrangement depicted in FIG. 3, a 60-degree FOV in the horizontal plane is covered (30 degrees on each side of the optical axis). Depending on the sizes and arrangement of the detectors, different FOVs can be achieved.

It should be noted that the invention can also be used to provide simulated spoken speech. In the above-described embodiments, switch commands are generated corresponding to spoken speech, and the switch commands correspond to the spoken speech itself, and a signal is created indicative of spoken speech, and the signal is indicative of the spoken speech itself, i.e. the signal conveys information about the speaker's voice, usually sufficient for a listener to identify the speaker if the listener knows the speaker, and providing intonation and other aspects of speech used to communicate meaning in case of spoken speech, as opposed to a writing conveying only the spoken words (with appropriate punctuation). For embodiments in which simulated spoken speech is provided, the switch commands corresponding to the spoken speech correspond only to the content of the spoken speech (i.e. conveying only the spoken words with appropriate punctuation), and the signal indicative of spoken speech is a signal indicative of simulated speech (i.e. artificial or computer-generated speech) and so corresponds only to the content of the spoken speech, i.e. it does not convey the information about the speaker's voice.

It is to be understood that the above-described arrangements are only illustrative of the application of the principles of the present invention. Numerous modifications and alternative arrangements may be devised by those skilled in the art without departing from the scope of the present invention.

What is claimed is:

1. An apparatus for communication, comprising:
a transmitter assembly, including a light source, responsive to a signal indicative of spoken speech, for providing light modulated by switch commands corresponding to the spoken speech; and
a receiver assembly, responsive to light modulated by switch commands, for providing a corresponding signal indicative of spoken speech.

2. An apparatus as in claim 1, wherein the transmitter assembly comprises:
a speech encoder, responsive to the signal indicative of spoken speech, for providing a digital speech signal indicative of the spoken speech;
a modulator, responsive to the digital speech signal, for providing switch commands corresponding thereto; and
a switched light source, including the light source, responsive to the switch commands, for providing the light modulated by the switch commands.

3. An apparatus as in claim 1, wherein the receiver assembly comprises:
a photodetector, responsive to the light modulated by switch commands, for providing a signal indicative of the switch commands;
a demodulator, responsive to the signal indicative of the switch commands, for providing a corresponding digital speech signal indicative of spoken speech; and
a speech decoder, responsive to the digital speech signal, for providing the signal indicative of spoken speech.

4. An apparatus as in claim 1, wherein the switch commands corresponding to the spoken speech correspond only to the content of the spoken speech, and wherein the signal indicative of spoken speech is a signal indicative of artificial or computer-generated speech corresponding only to the content of the spoken speech.

5. An apparatus as in claim 1, wherein the switch commands corresponding to the spoken speech correspond to the spoken speech as spoken.

6. An apparatus as in claim 1, wherein the receiver assembly is configured to provide switch commands conveyed by a received signal to the transmitter assembly if the receiver assembly determines that the received signal was not recently transmitted by the transmitter assembly according to a list of recently transmitted signals, and the transmitter assembly, in response to receiving such switch commands from the receiver assembly, is configured to provide a signal that echoes the received signal.

7. An apparatus as in claim 1, wherein at least the light source included in the transmitter assembly is housed in the housing of a lightbar, and is used to provide illumination at the same time as it is used by the transmitter assembly to provide communication.

8. An apparatus as in claim 7, wherein the transmitter assembly switches the light source on and off at a rate and in such a way that the light source appears to the human eye to be on continuously.

9. An apparatus as in claim 1, wherein at least the light source included in the transmitter assembly is kept turned off until it is used by the transmitter assembly to provide communication.

10. An apparatus as in claim 1, wherein the transmitter assembly uses Manchester encoding to create a bit stream corresponding to switch commands.

11. An apparatus as in claim 10, wherein the transmitter assembly turns on and off the light source at a first frequency to signal a bit in the bit stream having a value of 0, and at a second frequency to signal a bit in the bit stream having a value of 1, each of which frequencies are sufficiently high that the light source appears to a user to be on continually, wherein the user is equipped with night vision goggles if the light source is an infrared light source but otherwise is unaided by equipment.

12. An apparatus as in claim 1, wherein the transmitter assembly turns on and off the light source at a first frequency to signal a bit value of 0, and at a second frequency to signal a bit value of 1, each of which frequencies are sufficiently high that the light source appears to a user to be on continually, wherein the user is equipped with night vision goggles if the light source is an infrared light source but otherwise is unaided by equipment.

13. An apparatus as in claim 1, wherein the receiver assembly includes a photodetector and a lens, and the photodetector is disposed on an optical axis of the lens, at a point on the optical axis other than the focal point of the lens, and sufficiently far from the focal point so that an image provided by the lens is distributed over substantially all of the photodetector.
